(19) United States
(12) Patent Application Publication
(10) Pub. No.: US 2016/0019697 A1
(43) Pub. Date: Jan. 21, 2016

(54) DEVICE DISPLAY PERSPECTIVE ADJUSTMENT

(71) Applicant: International Business Machines Corporation, Armonk, NY (US)

(72) Inventors: Hamish C. Hunt, Ashford (GB); Nicholas K. Lincoln, Stockbridge (GB); Christopher J. Poole, Romsey (GB); Mark A. Woolley, Winchester (GB)

(21) Appl. No.: 14/737,373

(22) Filed: Jun. 11, 2015

(30) Foreign Application Priority Data
Jul. 18, 2014 (GB) 1412779.9

(51) Int. Cl. G06T 7/00; G06T 3/60; G06K 9/00; G06F 3/01; G06F 3/00

(52) U.S. Cl. CPC G06T 7/0042; G06F 3/013; G06F 3/012; G06F 3/005; G06K 9/00295; G06T 3/60; G06T 2207/10004; G06T 2207/30201

(57) ABSTRACT

This invention relates to a system, method and computer program product for displaying a picture on a device display comprising: identifying a person from a new face in an device camera image; identifying a reference eye separation distance of the identified viewer; calculating distance and angle of the new face from the device based on the reference eye separation and an image eye separation; applying a perspective transformation on picture based on the distance and angle of the new face; and displaying the transformed picture on the device display.

### BACKGROUND

This invention relates to a method and apparatus for device display perspective adjustment. In particular this relates to a method and apparatus for adjusting the perspective of a device display.

Smart devices, including Smart TVs and more portable hand held devices, are prevalent sources of media consumption. Media consumption is becoming more personalized to a user, with the displays being tailored to the desired user orientation. A prime example of this is the ability of smart devices to use facial recognition to orient the screen “vertical” on the device depending on the perceived orientation of a user's face and not relying on a gravitational indication of “up”. These features hint towards the ability of a user to deviate away from the expected usage. As such, a scenario whereby a user is not sitting upright when viewing media is answered. However, other complications may arise such as if the user is not facing the image display square on, or if a user is looking at an image with their eye line perpendicular to the image, then what is seen is an image of a square. If the image is tilted so that it is no-longer perpendicular to the eye line image plane, the square displayed on the device becomes a trapezoid viewed by the user due to the shift in perspective.

### SUMMARY

In a first aspect of the invention there is provided a system for displaying a picture on a device display comprising: a face recognition engine for identifying a person from a new face in an device camera image; an eye separation engine for identifying a reference eye separation distance of the identified person; a perspective distance engine for calculating distance and angle of the new face from the device based on actual eye separation distance and reference eye separation distance; a picture perspective transformation engine for applying a perspective transformation on picture based on the distance and angle of the new face; and a device display driver for displaying the transformed picture on the device display.

The first aspect of the invention may also include a face orientation engine for identifying face orientation of the new face and wherein the calculation of distance and angle takes into account the identified face orientation. The first aspect of the invention may further include a device reference transformation engine for calculating distance and angle of the new face in the device display frame of reference. The picture can also be a frame in a video. Additionally, the system may be initiated when a new face is detected in the camera image or when a face has moved position in the camera image. If a face cannot be recognized, a standard eye separation distance may be used.

In a second aspect of the invention there is provided a method for displaying a picture on a device display comprising: identifying a person from a new face in an device camera image; identifying a reference eye separation distance of the identified person; calculating distance and angle of the new face from the device based on the reference eye separation and an actual eye separation distance; applying a perspective transformation on picture based on the distance and angle of the new face; and displaying the transformed picture on the device display.

This embodiment proposes a method to overcome this perspective shift to enable a user to see the best possible image as their viewpoint of the media diverts from the assumed “square on”.

By use of existing facial recognition techniques to identify: a person, the orientation of the person's head; and the angle and/or the transformation at which the person is viewing the display screen. The device can tailor the display output to adjust for the perspective induced distortions resulting from not viewing the screen perpendicularly.

The smart device is assumed to be equipped with a front facing camera, as is typically present on smart phones, tablets, and smart-TVs. The location and orientation of the camera with respect to the display screen is assumed to be known. The camera is used to identify a single user by implementing known facial recognition algorithms.

Having identified a person and the orientation of the person's head, the location of a person can be identified within the camera frame of reference. By applying a known transform that maps points in the camera image to pixel locations in the display screen, the location of a person within the display screen frame of reference can be identified.

Facial identification is based upon feature extraction from images and identifies a face as distinct from other objects. Once facial identification of a user is made then a reference value for the user's inter-eye measured is used to estimate a distance from the camera. Each person on the system has their inter-eye distance is measured although an average value 63 mm could be used for an unknown person. Based on this, and knowledge of the central pixel, the angle at which the person is viewing the display screen may be determined and is shown for the 2D case in the figure below.

Using trigonometric relationships or a computationally more tractable transform matrix that may account for scale, skew and rotation, the display screen output may be altered to ensure that the person may view the image as if they are viewing the display screen at a perpendicular angle.

Applying perspective adjustment will cause pixel loss at the extremities and this is an unavoidable result of the transformation being applied to the image.

The embodiments have a physical effect of changing the picture as seen by the viewer. The embodiments have a real effect that operates at a system level of a computer and below any overlying applications. The embodiments have a realistic effect on pictures that would enable further improvements to the picture usability such that the computer is operating in a new way.

In a third aspect of the invention there is provided a computer program product for displaying a picture on a device display comprising: identifying, the computer program product comprising a computer-readable storage medium having computer-readable program code embodied therewith and the computer-readable program code configured to perform all the steps of the methods.

The computer program product comprises a series of computer-readable instructions either fixed on a tangible medium, such as a computer readable medium, for example, optical disk, magnetic disk, solid-state drive or transmittable to a computer system, using a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In a fourth aspect of the invention there is provided a computer program stored on a computer readable medium and loadable into the internal memory of a computer, comprising software code portions, when said program is run on a computer, for performing all the steps of the method claims.

In a fifth aspect of the invention there is provided a data carrier aspect of the preferred embodiment that comprises functional computer data structures to, when loaded into a computer system and operated upon thereby, enable said computer system to perform all the steps of the method claims. A suitable data-carrier could be a solid-state memory, magnetic drive or optical disk. Channels for the transmission of data may likewise comprise storage media of all descriptions as well as signal-carrying media, such as wired or wireless signal-carrying media.

### BRIEF DESCRIPTION OF THE SEVERAL VIEWS OF THE DRAWINGS

Preferred embodiments of the present invention will now be described, by way of example only, with reference to the following drawings in which:

FIG. 1 is a deployment diagram of the preferred embodiment;

FIG. 2 is a component diagram of the preferred embodiment;

FIG. 3 is a flow diagram of a process of the preferred embodiment;

FIGS. 4A and 4B show an example picture when seen from different view angles;

FIG. 5 is a schematic example diagram of a device and camera in relation to a user;

FIG. 6 is a schematic diagrams of camera frame and display frame for the previous example;

FIG. 7 is a schematic diagram of the display, camera and user and showing an estimated distance and view angle; and

FIG. 8 shows an example display picture and corresponding observed picture for a given view angle.

### DETAILED DESCRIPTION

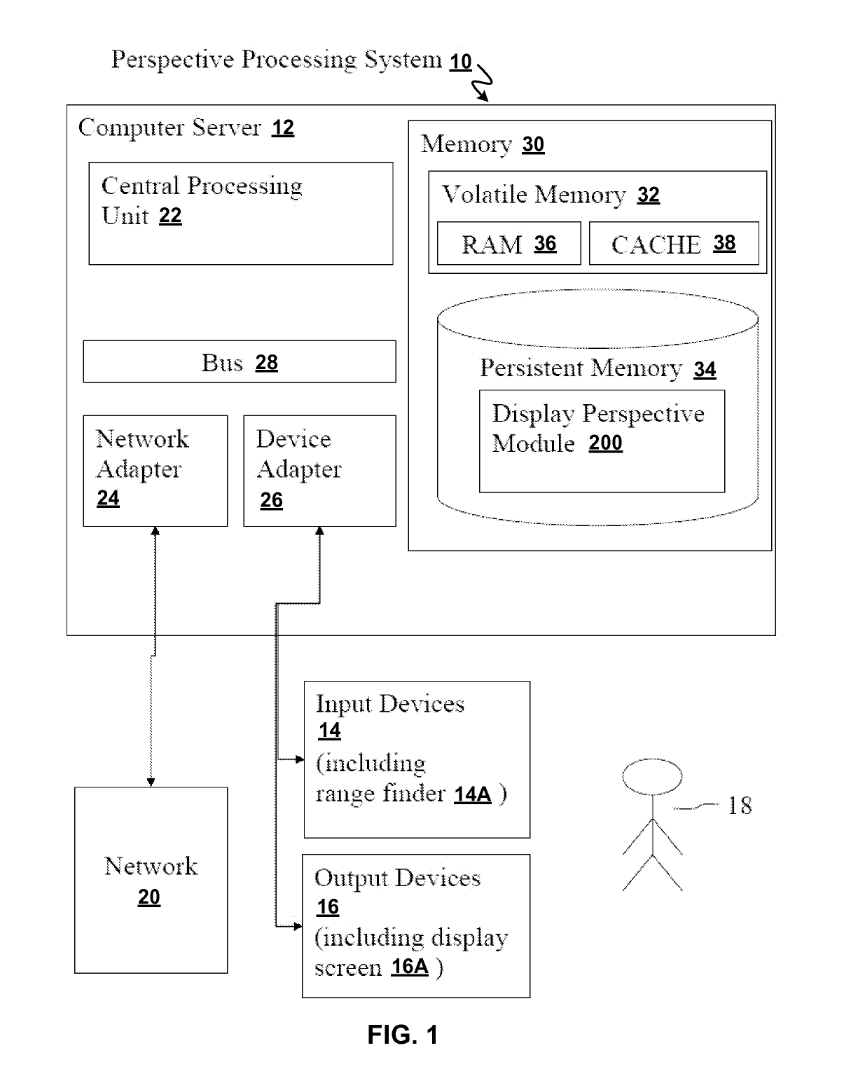

Referring to FIG. 1, the deployment of a preferred embodiment in perspective processing system 10 is described. Perspective processing system 10 is operational with numerous other general purpose or special purpose computing system environments or configurations. Examples of well-known computing processing systems, environments, and/or configurations that may be suitable for use with perspective processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Perspective processing system 10 may be described in the general context of computer system-executable instructions, such as program modules, being executed by a computer processor. Generally, program modules may include routines, programs, objects, components, logic, and data structures that perform particular tasks or implement particular abstract data types. Perspective processing system 10 may be embodied in distributed cloud computing environments where tasks are performed by remote processing devices that are linked through a communications network. In a distributed cloud computing environment, program modules may be located in both local and remote computer system storage media including memory storage devices.

Perspective processing system 10 comprises: general-purpose computer server 12 and one or more input devices 14 and output devices 16 directly attached to the computer server 12. Perspective processing system 10 is connected to a network 20 and communicates with a user 18 using input devices 14 (in particular range finder 14A) and output devices 16 (in particular display screen 16A). Other input devices 14 include one or more of: a keyboard, a scanner, a mouse, trackball or another pointing device. Other output devices 16 include one or more of a display or a printer. Perspective processing system 10 communicates with network devices (not shown) over network 20. Network 20 can be a local area network (LAN), a wide area network (WAN), or the Internet.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations include: incrementing or decrementing a value in a register; transferring a value from memory 30 to a register or vice versa; branching to a different location in memory if a condition is true or false (also known as a conditional branch instruction); and adding or subtracting the values in two different registers and loading the result in another register. A typical CPU can perform many different machine operations. A set of machine instructions is called a machine code program, the machine instructions are written in a machine code language which is referred to a low level language. A computer program written in a high level language needs to be compiled to a machine code program before it can be run. Alternatively a machine code program such as a virtual machine or an interpreter can interpret a high level language in terms of machine operations.

Network adapter 24 is connected to bus 28 and network 20 for enabling communication between the computer server 12 and network devices.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Generally volatile memory is used because it is faster and generally non-volatile memory is used because it will hold the data for longer. Computer processing system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The set of program modules configured to carry out the functions of the preferred embodiment includes display perspective module 200. Further program modules that support the preferred embodiment but are not shown include firmware, boot strap program, operating system, and support applications. Each of the operating system, support applications, other program modules, and program data or some combination thereof, may include an implementation of a networking environment.

Computer processing system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with computer processing system 10. Examples, include, but are not limited to: microcode, device drivers, redundant processing units, external disk drive arrays, redundant array of independent disks (RAID), tape drives, and data archival storage systems.

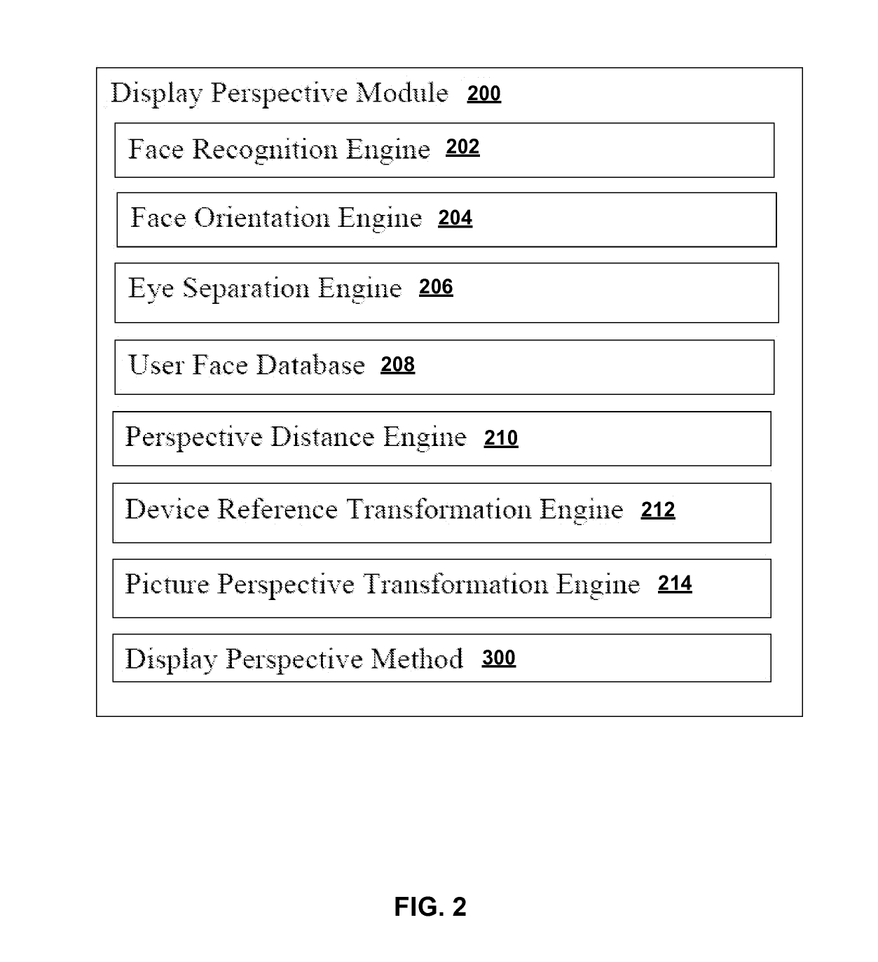

Referring to FIG. 2, module 200 comprises the following interactive components: face recognition engine 202; face orientation engine 204; eye separation engine 206; user face database 208; perspective distance engine 210; device reference transformation engine 212; picture perspective transformation engine 214; and a display perspective method 300.

Face recognition engine 202 comprises known technology for recognizing a face of a user in a camera device image using faces in a user face database 208.

Face orientation engine 204 is for estimating an orientation of a user's face and in particular the orientation of a line connecting the eyes. Typically this value is extracted by querying the face recognition engine 202.

Eye separation engine 206 is for calculating a normalized eye separation distance using a value from the face recognition engine 202 and a value for the face orientation. Normalized is when the eyes are parallel to the device display.

User face database 208 is for storing user face data including: standard eye separation; features needed to identify a face; and features needed to identify an orientation of the face.

Perspective distance engine 210 is for finding the distance of a user from the device camera.

Device reference transformation engine 212 is for transforming the range and angle of a user (or an average for a group of users) into a range and angle for the device display.

Picture perspective transformation engine 214 is for applying a perspective transformation to the picture or video using the range and angle for the display device.

Display perspective method 300 is for controlling the components of the display perspective module 200 for performing the preferred embodiment.

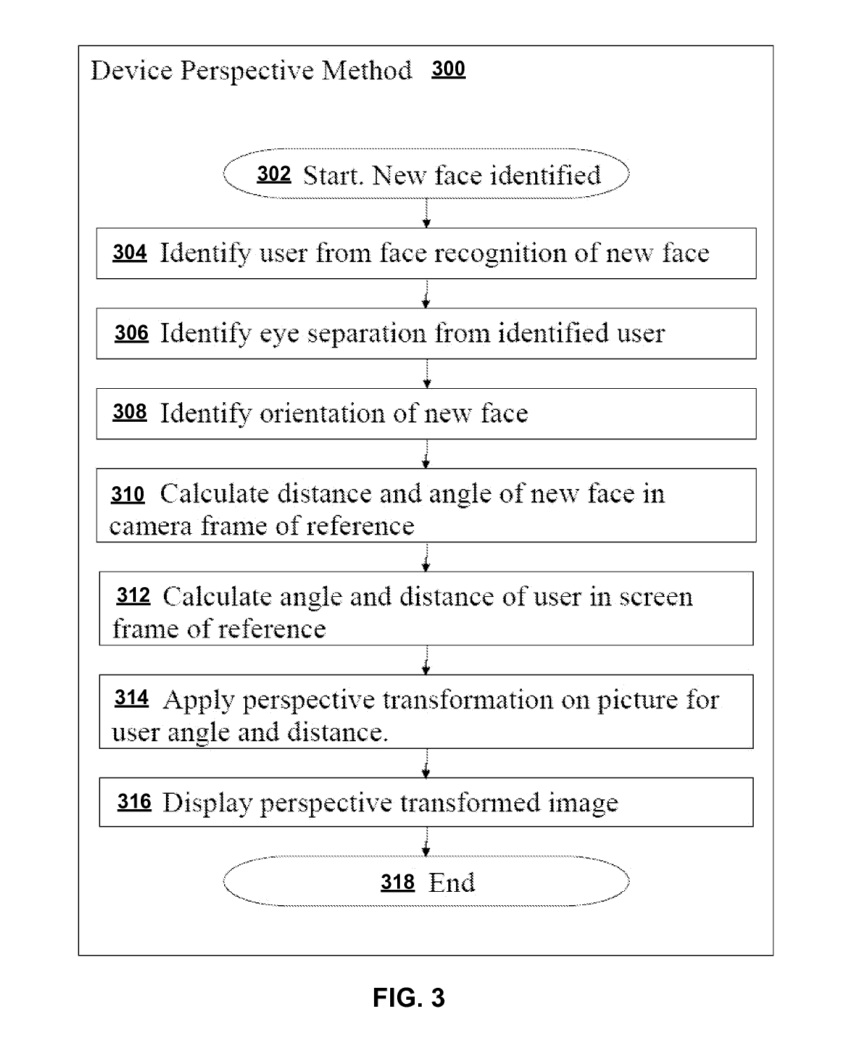

Referring to FIG. 3, display perspective method 300 comprises logical process steps 302 to 318.

Step 302 is the start of the method initialized when a new face or a new position of a known face is identified from the camera.

Step 304 is for identifying a user from face recognition of the new face.

Step 306 is for identifying a standard eye separation for the identified user from the user face database.

Step 308 is for identifying orientation of the new face.

Step 310 is for calculating the angle and distance of the new face in the frame of reference of the perspective distance engine 210.

Step 312 is for calculating the angle and distance of the user in the frame of reference of the device display using the relative position of the device camera and the device display.

Step 314 is for applying a perspective transformation on the picture or video.

Step 316 is for displaying the transformed picture or video on the display device.

Step 318 is the end of the device perspective method 300.

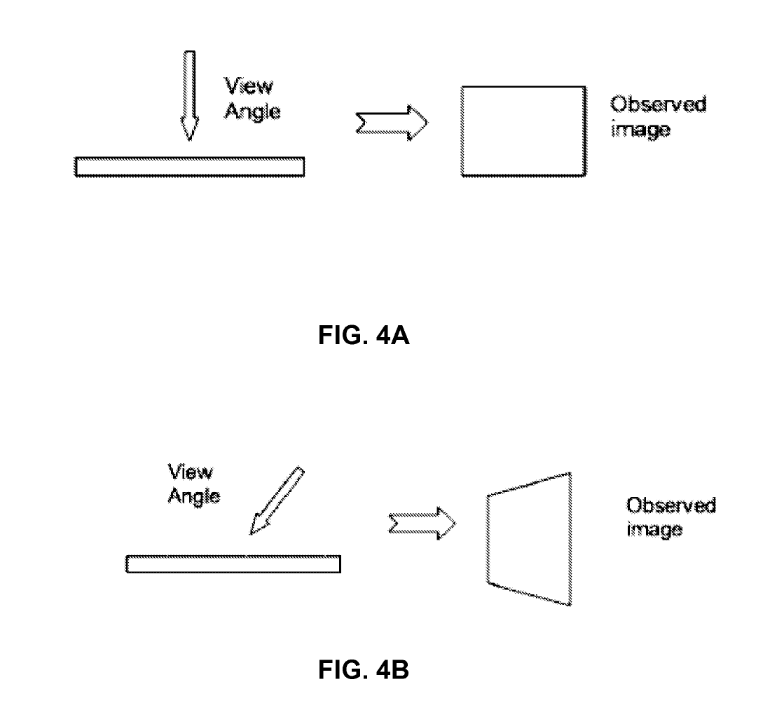

FIGS. 4A and 4B show an example picture seen from different view angles. The picture in FIG. 4B is tilted so that it is no-longer perpendicular to the eye line image plane, the square displayed on the device becomes a trapezoid viewed by the user due to the shift in perspective.

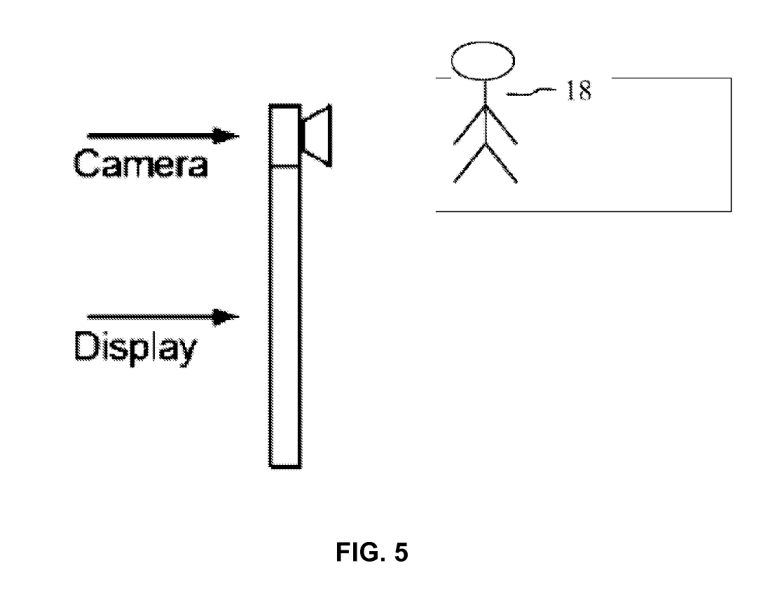

FIG. 5 is a schematic example diagram of a device display and a camera device with a user opposite the camera and at an acute angle to the display.

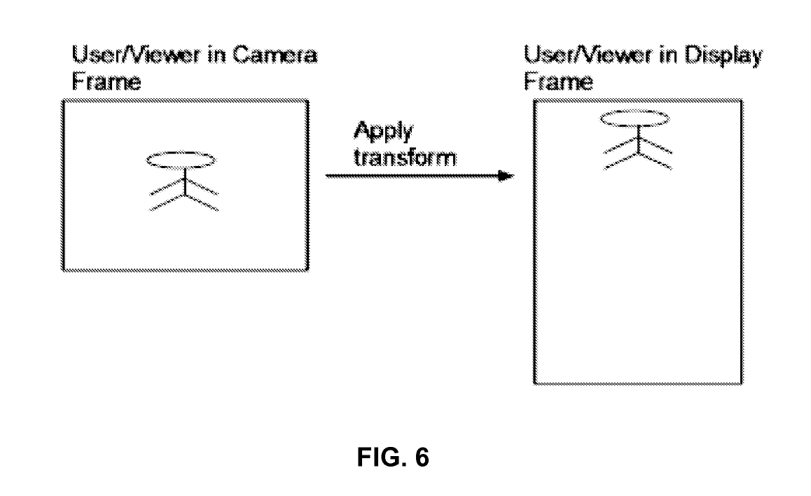

FIG. 6 is a schematic diagram of a camera frame and display frame for the respective previous example. In FIG. 6 the user is in the center of the camera frame but after the transformation, the user in the middle upper part of the display frame because the camera is located to one side of the display frame.

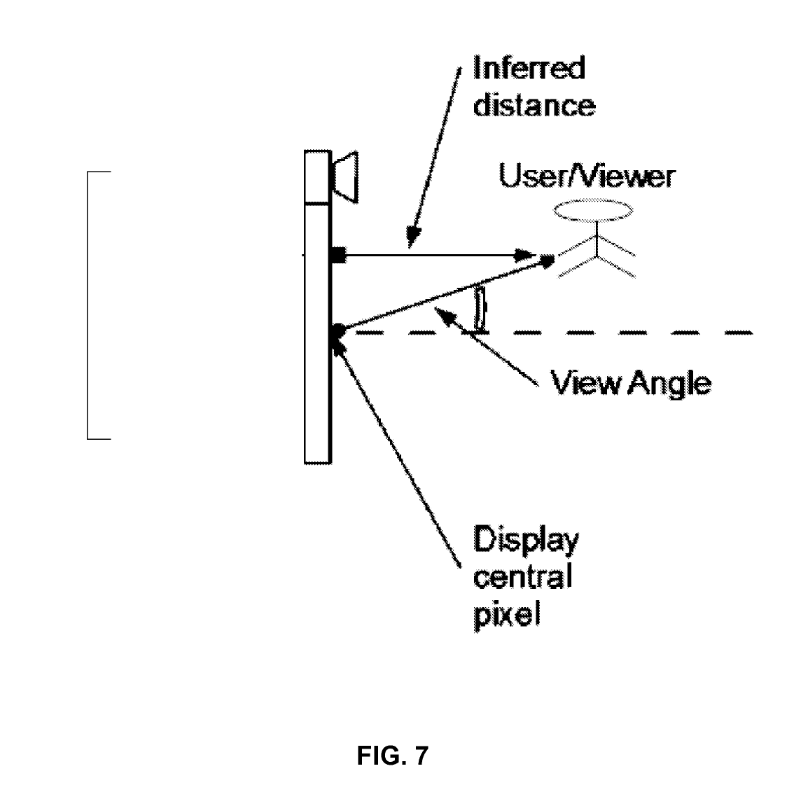

FIG. 7 is a schematic diagram of the display, camera and user and showing an inferred distance and view angle to the user. The view angle is calculated from a line normal to a central pixel on the device display.

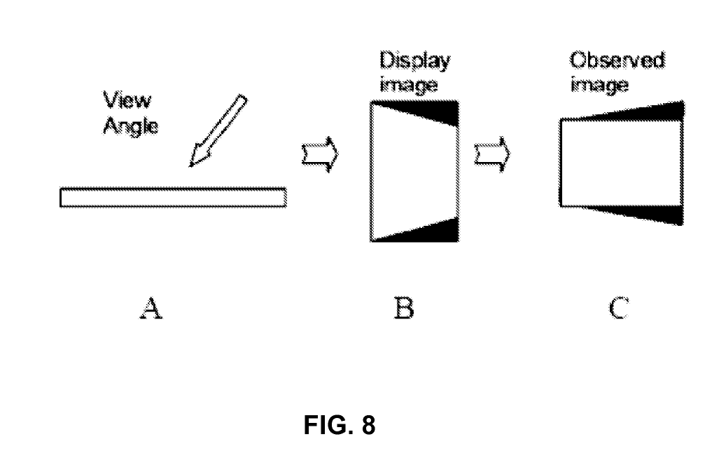

FIG. 8 shows an example display image and corresponding observed image for a given view angle.

A user is viewing the device display (A) at a view angle acute from the normal angle.

An image (B) that starts life as a rectangle is transformed into a display image that is trapezoid when perspective in introduced.

However, the observed image (C) will be seen as a rectangle by the user because of the transformation applied by the embodiment.

It will be equally clear to one of skill in the art that all or part of the logic components of the preferred embodiment may be alternatively embodied in logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of the preferred embodiment may alternatively be embodied fully or partially in a parallel computing system comprising two or more processors for executing parallel software.

A further embodiment of the invention is a computer program product defined in terms of a system and method. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer-readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be clear to one skilled in the art that many improvements and modifications can be made to the foregoing exemplary embodiment without departing from the scope of the present invention.

What is claimed is:

1. A system for displaying a picture on a device display comprising:
a face recognition engine for identifying a person from a new face in a device camera image;
an eye separation engine for locating a reference eye separation distance of the identified person;
a perspective distance engine for calculating distance and angle of the new face from the device based on the reference eye separation and an image eye separation;
a picture perspective transformation engine for applying a perspective transformation on picture based on the distance and angle of the new face; and
a device display driver for displaying the transformed picture on the device display.

2. The system of claim 1, further comprising:
a face orientation engine for identifying face orientation of the new face and wherein the calculation of distance and angle takes into account the identified face orientation.

3. The system of claim 1, further comprising:
a device reference transformation engine for calculating distance and angle of the new face in the device display frame of reference.

4. The system of claim 1, wherein the picture can be a frame in a video.

5. The system of claim 1, wherein the system is initiated when a new face is detected in the camera image.

6. The system of claim 1, wherein the system is initiated when a face has moved position in the camera image.

7. The system of claim 1, wherein a standard eye separation distance is used if a face cannot be recognized.

8. A method for displaying a picture on a device display comprising:
identifying a person from a new face in a device camera image;
identifying a reference eye separation distance of the identified person;
calculating distance and angle of the new face from the device based on the reference eye separation distance and an image eye separation distance;
applying a perspective transformation on picture based on the distance and angle of the new face; and
displaying the transformed picture on the device display.

9. The method of claim 8, further comprising:
identifying head orientation of the new face and wherein the calculation of distance and angle takes into account the identified head orientation.

10. The method of claim 8, further comprising:
calculating distance and angle of the new face in the device display frame of reference.

11. The method of claim 9, wherein the picture can be a frame in a video.

12. The method of claim 9, wherein the method is initiated when a new face is detected in the camera image.

13. The method of claim 9, wherein the method is initiated when a face has moved position in the camera image.

14. The method of claim 9, wherein a standard eye separation distance is used if a face cannot be recognized.

15. A computer program product for displaying a picture on a device display, comprising:
one or more computer-readable storage medium and program instructions stored on at least one of the one or more tangible storage medium, the program instructions executable by a processor, the program instructions comprising:
program instructions to identify a person from a new face in a device camera image;
program instructions to identify a reference eye separation distance of the identified person;
program instructions to calculate distance and angle of the new face from the device based on the reference eye separation distance and an image eye separation distance;
program instructions to apply a perspective transformation on picture based on the distance and angle of the new face; and
program instructions to display the transformed picture on the device display.

16. The computer program product of claim 15, further comprising:
program instructions to identify head orientation of the new face and wherein the calculation of distance and angle takes into account the identified head orientation.

17. The computer program product of claim 15, further comprising:
program instructions to calculate distance and angle of the new face in the device display frame of reference.

18. The computer program product of claim 16, wherein the picture can be a frame in a video.

19. The computer program product of claim 16, wherein the computer program product is initiated when a new face is detected in the camera image.

20. The computer program product of claim 16, wherein the computer program product is initiated when a face has moved position in the camera image.
